(19) United States
(12) Patent Application Publication
(10) Pub. No.: US 2025/0012598 A1
(43) Pub. Date: Jan. 9, 2025

(54) Method, Server Apparatus, and Motor Vehicle for Automatically Mapping Sections of a Surrounding Area

(71) Applicant: Volkswagen Aktiengesellschaft, Wolfsburg (DE)

(72) Inventors: Stefan Wappler, Söllingen (DE); Timo Iken, Wittingen (DE); Niklas Koch, Tappenbeck (DE); Roland Kube, Schwülper (DE)

(73) Assignee: Volkswagen Aktiengesellschaft, Wolfsburg (DE)

(21) Appl. No.: 18/711,676

(22) PCT Filed: Oct. 25, 2022
(86) PCT No.: PCT/EP2022/079709

§ 371 Date: May 20, 2024

(30) Foreign Application Priority Data
Nov. 23, 2021 (DE) 10 2021 213 147.6

(51) Int. Cl. G01C 21/00

(52) U.S. Cl. CPC G01C 21/3841; G01C 21/3815

(57) ABSTRACT

The disclosure relates to a method and to a server apparatus and to a motor vehicle for automatically mapping a surrounding area. In the method, the server apparatus creates a route network map of the surrounding area from odometry data from a fleet of respective motor vehicles. The server apparatus generates a mapping plan for mapping sections of the surrounding area. The mapping plan divides the surrounding area into multiple subareas and defines at least one subarea that is still to be mapped. The fleet vehicles are then iteratively instructed to collect surroundings data in accordance with the mapping plan only for subareas that are still to be mapped and to transmit said surroundings data to the server apparatus, and the mapping plan is accordingly updated based on the received surroundings data in order to avoid collecting and transmitting redundant surroundings data for subareas that have already been mapped.

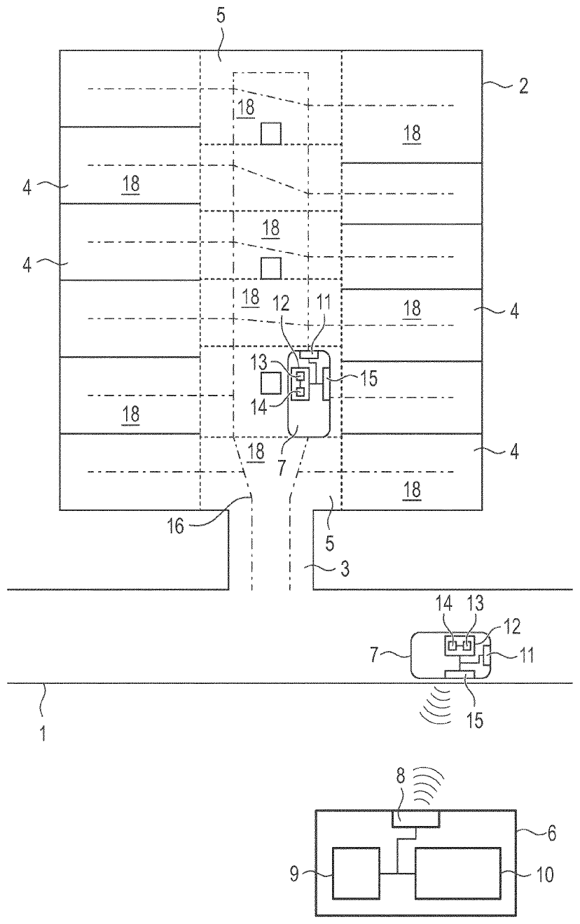

### CROSS-REFERENCE TO RELATED APPLICATIONS

This application claims priority to German Patent Application No. DE 10 2021 213 147.6, filed on Nov. 23, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method for automatically mapping a surrounding area. The disclosure further relates to a server apparatus that is configured for a method of this kind and to a motor vehicle which is configured to participate in the method or to support the method.

Mapping of a traffic area in as accurate and complete a manner as possible can make possible or support many automated applications and functions, in particular of vehicles but also in other technical fields. However, mapping of this kind can also be associated with considerable effort, and therefore automation is desirable. However, this also throws up challenges, in particular with regard to the collection, transmission, and processing of corresponding data as well as with regard to the completeness of the mapping of more demanding or complex traffic or surrounding areas. Further developments and improvements are therefore needed in order to make possible or support mapping, in particular automated mapping.

### SUMMARY

A need exists to provide an efficient and reliable automatic mapping of surrounding areas which cannot readily be mapped automatically using conventional methods and motor vehicles.

The need is addressed by the subject matter of the independent claim(s). Embodiments of the invention are described in the dependent claims, the following description, and the drawings.

### BRIEF DESCRIPTION OF THE DRAWING

The single FIGURE shows a schematic overview for illustrating an example automatic mapping of a parking garage by means of an example system consisting of a server apparatus and a fleet of motor vehicles.

### DESCRIPTION

The details of one or more embodiments are set forth in the accompanying drawings and the description below. Other features will be apparent from the description, drawings, and from the claims.

The method according to the teachings herein serves, i.e., can be used or applied, to automatically map at least one or, alternatively, a respective, in particular a predefined, surrounding area. A surrounding area of this kind may comprise a particular outdoor and/or indoor area, a traffic area, an infrastructure area, an at least partially trafficable structure, a building or construction, and/or the like. The method comprises multiple method steps which can be executed, i.e., carried out, in particular automatically or semi-automatically, by means of a vehicle-external server apparatus. A vehicle-external server apparatus of this kind may, for example, be a computing center, a central server, a backend, a cloud server, or the like. The vehicle-external server apparatus can communicate via a line-free or rather wireless data connection or, alternatively, be connected to a corresponding data network. The data mentioned below may be sent or transmitted via a data connection or data network of this kind, i.e., for example via a mobile network, a WLAN connection, and/or the like.

In one method step of the method, odometry data from fleet vehicles or, alternatively, at least one fleet vehicle are recorded by means of the server apparatus. Said odometry data were collected, i.e., recorded or potentially also processed or pre-processed, from corresponding swarm or fleet vehicles, i.e., from vehicles of a fleet or swarm of such vehicles that are configured to support the method when same are traveling through the respective surrounding area. The odometry data indicate positions, trajectories, route sections, and/or areas within the respective surrounding area that are traveled to by the fleet vehicles.

The fleet vehicles may, in particular, be motor vehicles, but the method can ultimately be applied or adapted for or with almost any type of vehicle or mobile apparatus.

In another method step of the method, a route network map is created for the respective surrounding area by means of the server apparatus from or based on the recorded odometry data. A route network map of this kind may—unlike a highly detailed map (HD map) that can be used, for example, for automated navigation—indicate or comprise, for example, trajectories or lines and/or a sequence of driving maneuvers or driving or control instructions in a simplified manner, along which trajectories or lines or according to which maneuvers or instructions the fleet vehicles have actually moved within the respective surrounding area and which are therefore trafficable or, alternatively, extend through trafficable sections of the respective surrounding area. Already available route network data may also be used as the basis or foundation for creating the route network map. Route network data of this kind may be recorded or retrieved, for example, from corresponding data providers, for example mapping companies, collectors of movement data, mobile providers or mobile network operators, and/or the like. Equally, for example, aerial image data, satellite image data, image data from surveillance cameras arranged or stationed in the region of the surrounding area, and/or the like may be used as the basis or foundation for creating the route network map. For example, an at least rudimentary preliminary map or the route network map itself can be estimated from an aerial image or virtual globe data, for example a 2D or 3D Google Earth model. Corresponding estimation or modeling specifications may be defined for this purpose. For example, parking garages can often be constructed in a similar manner to or according to a known schema, a number of levels or floors can be recognized or estimated from image data or the like.

In another method step of the method, a mapping plan, i.e., a mapping schema or mapping specification for recording or rather mapping sections of the respective surrounding area, is created by means of the server apparatus based on the route network map. By means of this mapping plan, the respective surrounding area is split or divided into multiple subareas. The mapping plan defines at least one subarea of this kind which is still to be recorded or, alternatively, which is to be recorded next, i.e., which is still to be mapped, by the fleet vehicles. The mapping plan may thus split or divide the surrounding area into multiple subareas or into a large number of subareas which, for example, have a maximum predefined size or which cover or encompass a maximum predefined route or area. Equally, the subareas may be defined, for example, based on a granularity of the mapping or of the surroundings data to be collected. For example, different resolution or detail levels may be predefined for the mapping or rather for the collection of the surroundings data. A corresponding scale, for example, can be predefined for this purpose, for example from “coarse” to “medium” to “fine”. Equally, the subareas can be defined by or as different object or surface types. For example, a subarea may only comprise particular surfaces, for example walls and/or floor surfaces, and one or more other subareas may, for example, only comprise particular types or classes of objects, for example columns, barriers, railings, boundaries, lighting apparatuses, electrical apparatuses or devices, plants, stationary fixtures or fittings, and/or the like. The subareas may be determined depending on the respective route network map, i.e., have the same or different sizes and/or shapes. Depending on the type or definition, a particular subarea may in each case be spatially contiguous or comprise spatially separated regions, areas, and/or elements. Initially, i.e., when there are still no further data for the respective surrounding area, all of these subareas can be classified or designated as still to be mapped or as the next to be mapped. Equally, precisely one of the subareas or a subset of the subareas, for example, may initially be classified or designated as the next to be mapped. In particular, initially only or at least one subarea that follows on from an entrance into the surrounding area or a subarea comprising said entrance may be defined or designated or rather earmarked as the one to be mapped or as the next to be mapped. The corresponding definition, classification, or designation of the at least one subarea or of the subareas may be part of the mapping plan or be indicated, for example, in the form of corresponding metadata or the like.

In another method step of the method, the server apparatus instructs the fleet vehicles or at least one of the fleet vehicles or some of the fleet vehicles in accordance with the mapping plan, in each case when they next travel through the surrounding area, i.e., in the respective surrounding area, to collect surroundings data by means of a respective surroundings sensor system specific to the vehicle only for the at least one subarea of the surrounding area still to be mapped or to be mapped next.

The surroundings data can be collected as raw data and/or in processed or pre-processed form. For example, the surroundings data may—for example depending on the equipment of the respective fleet vehicle—be or comprise radar echoes, lidar scan data, ultrasound data, camera images, friction coefficient data, slip data, brightness data, climate or weather data, temperature data, and/or the like and/or data generated or derived therefrom.

The fleet vehicles are further instructed to transmit the surroundings data collected for the at least one subarea still to be mapped or to be mapped next to the server apparatus, for example if or as soon as a data connection enabling this between the respective fleet vehicle and the server apparatus can be set up or established or, alternatively, has been set up.

Therefore, the fleet vehicles can in this case implicitly or explicitly be instructed to collect or, alternatively, to temporarily store no surroundings data for subareas of the surrounding area that have already been mapped—at least sufficiently well according to a corresponding specification—and thus not to transmit said data to the server apparatus either. Thus, in this case, surroundings data are collected, or alternatively recorded by means of the server apparatus, in a targeted manner or rather selectively for the at least one subarea of the respective surrounding area that is still to be mapped or that is to be mapped next.

By means of the server apparatus, a map of the surrounding area is generated or, alternatively—if an already existing map is available—updated, improved, and/or completed based on the cumulatively received surroundings data. Additionally, by means of the server apparatus, the mapping plan is updated or adapted accordingly in order to avoid or rather prevent collection and transmission of redundant surroundings data for already mapped subareas of the surrounding area by means of the fleet vehicles. For this purpose, for example in the mapping plan, the subarea that is next in each case or, alternatively, another subarea that has not yet been mapped or that has not been mapped to a sufficiently accurate extent or that has not been mapped completely can be marked as the subarea to be mapped next. Equally, a subarea that was classified as still to be mapped or as the next to be mapped can then be classified or designated in the mapping plan as already mapped as soon as surroundings data that allow for generation of the corresponding part of a map of the surrounding area by means of the server apparatus have been recorded for this subarea. The corresponding instruction of the fleet vehicles, the generation or, alternatively, updating of the map, and the corresponding updating or adaptation of the mapping plan and a correspondingly adapted instruction of the fleet vehicles can be carried out iteratively, i.e., repeated multiple times in an updated or adapted form in each case based on the data available at the relevant time. This can be carried out or repeated until, for example, the entire surrounding area has been mapped, i.e., until the map of the surrounding area has been fully generated.

Equally, these iterative method steps or the entire method can be carried out again for a surrounding area already mapped in the past, for example on a regular basis or with a predefined frequency, in order to perform a check or update of the map generated last in each case for the respective surrounding area.

In order to create and/or adapt the mapping plan or, alternatively, a corresponding mapping strategy, the frequency with which subareas were traveled through with surroundings data being collected can be recorded, for example, in each case statistically. For example, a target or threshold value for the number of surroundings datasets can be predefined for each subarea. Based on this, it can then be automatically determined for which subareas sufficient surroundings data have already been recorded or, alternatively, for which there is sufficiently good data coverage, i.e., which subareas can be classed as mapped. Equally, however, it can be taken into account that, in parking structures, more frequent travel indicates more frequent parking or re-parking procedures and parking vehicles can impair the collection of surroundings data. Thus, for correspondingly highly frequented subareas, a larger number of surroundings datasets can be requested or recorded before the corresponding subarea is classed as mapped. Equally, when generating or adapting the mapping plan or, alternatively, mapping strategy, for example the respective target or threshold value for the number and/or type of surroundings datasets, the time, day of the week, weather conditions, and/or the like can be taken into account. Thus, surroundings datasets collected under accordingly different conditions can, for example, be weighted differently, wherein a predefined sum of corresponding weightings must be achieved for each subarea before the subarea is classed as mapped. Equally, a subarea may, for example, only be classed as mapped if multiple surroundings datasets collected under different conditions or surroundings datasets collected under at least one or more conditions have been recorded.

The creation and/or adaptation of the mapping plan or, alternatively, a corresponding mapping strategy can be based on classing the next spatially adjoining subarea in each case as the next to be mapped proceeding from the current or previous mapping scope or mapping status of at least one subarea. However, this is not strictly necessary. Equally, it can, for example, be taken into account at least intermittently or temporarily that, spatially between two mapped subareas or two subareas to be mapped or, alternatively, between a mapped subarea and a subarea for which surroundings data are currently being collected and recorded or are to be collected and recorded next, there may be at least one subarea that has not yet been mapped or that has not been mapped completely. For example, a mapping order of the subareas can be defined based on the significance or importance thereof, for example for a traffic flow or an accident probability within the surrounding area or measured in terms of an actual or likely frequentation or traffic density. For example, subareas or subarea types or sections defined in a predefined manner as strategically important, for example intersections or area that are traveled through with above-average frequency or a lot, can be preferentially mapped or mapped as a priority. This has the benefit that the mapping process is not hindered by the fact that particular subareas are or are being traveled through less and, accordingly, no or not enough or not sufficiently diverse surroundings datasets can be recorded for these subareas for a relatively long period of time.

A control variable or basis for creating and/or adapting the mapping plan or, alternatively, a corresponding mapping strategy may be through a respective degree or quality of the mapping or rather of the recorded surroundings data for the subareas. This may, for example, be determined or measured based on a convergence or, alternatively, a predefined convergence criterion of the mapping of the respective subarea, i.e., a corresponding partial map generated for the respective subarea. For example, when a particular degree of convergence has been reached or when the predefined convergence criterion has been met for a particular subarea, said subarea can then be classed as mapped. The convergence may, for example, be determined as or based on the changes in the respective partial map over time or per predefined time period. Subareas for which there is no convergence, i.e., for which there are changes to the corresponding partial map that exceed a predefined threshold value after a surroundings dataset has been recorded and processed, can also be or, alternatively, remain classed as not mapped or not sufficiently mapped, i.e., as to be mapped or as to be mapped next. In this way, the map can then also be automatically updated if, for example, there is one or more subareas in which changes often occur.

Another control variable or basis for creating and/or adapting the mapping plan or, alternatively, a corresponding mapping strategy may be a type of the surroundings data already recorded for a respective subareas. For example, a predefined prioritization or hierarchy of different types of surroundings data may be predefined. After surroundings data have been recorded for a subarea, the mapping plan or, alternatively, the mapping strategy can then be adapted such that no further surroundings data of a lower prioritization or hierarchical level are to be collected for this subarea. For example, lidar data may be classed higher than radar data. Then, the collection of radar data may be dispensed with for future travel through a subarea for which lidar data have already been recorded.

On account of the possibilities proposed here, the quality, accuracy, reliability, and/or completeness and thus the usefulness of the ultimately generated map can be improved.

By means of the method, staggered or, alternatively, region-by-region data collection or measurement or mapping can be realized or, alternatively, ensured for the surrounding area. Thus, it can be achieved or ensured in a particularly reliable manner that, ultimately, the entire surrounding area is mapped. By means of the method, a data volume for the automatic mapping and transmission of ultimately unnecessary redundant data can be significantly reduced or, alternatively, kept particularly small. This can reduce loading of corresponding data networks as well as data processing effort and associated energy consumption compared with conventional methods.

In addition, the method can then also be applied successfully for completely mapping the respective surrounding area if the fleet vehicles have limited storage capacities for temporarily storing the surroundings data, such that in each case they cannot hold, i.e., temporarily store, surroundings data for the entire surrounding area and such that, for example, no streaming or, alternatively, real-time transmission of the surroundings data from the fleet vehicles to the server apparatus is possible in the surrounding area. In such a case, previous methods would potentially result in the fleet vehicles, after entering the respective surrounding area, repeatedly recording and temporarily storing surroundings data for the same subareas of the surrounding area that are close to the point of entry or entrance and redundantly transmitting said data to the server apparatus. However, subareas that are further away from the entrance into the surrounding area would not be recorded reliably or completely and thus ultimately not mapped, since the temporary memories of the fleet vehicles would already be full when they reach the subareas that are further away from the entrance. This is prevented in the present method in that, after the subareas close to the point of entry or entrance have been mapped, the fleet vehicles are instructed not to collect or, alternatively, temporarily store surroundings data for these subareas. Therefore, the fleet vehicles can then gradually record all subareas, i.e., also the subareas that are further away from the entrance into the surrounding area, and send corresponding surroundings data to the server apparatus.

Particularly beneficially, the method may be applied without additional and costly hardware in the fleet vehicles, unlike in conventional setups. Therefore, the method may be applied particularly efficiently not only by preventing redundant surroundings data from being collected and transmitted, but also by preventing corresponding additional hardware expenditure.

In some embodiments, the surrounding area is identified, in particular by means of the server apparatus, based on predefined map data and/or metadata that identify the surrounding area as a trafficable area, without indicating, i.e., comprising or providing, a detailed map of the surrounding area. The map data and/or metadata may identify or indicate the surrounding area, for example, via the function thereof and/or by the spatial position or outer boundaries thereof. For example, a parking structure, in particular a parking garage, or the like can be designated as such and thus as a surrounding area within the context of the present disclosure in the map data and/or metadata without said data necessarily indicating an internal structure or route structure or other details of the surrounding area. The embodiments proposed here allow for particularly simple, at least partially automated identification of surrounding areas to be mapped for which the method can be applied in a beneficial manner. Therefore, the method can be applied in a particularly simple manner, since corresponding map data and/or metadata are already available or can be generated in a particularly simple and low-effort manner for extensive areas.

Equally, within the context of the present teachings, the or a surrounding area to be mapped may be identified by the fleet vehicles, for example as a region or area which is being or has been traveled through by at least one of the fleet vehicles, but for which no map or map data is available or retrievable. As a result, within the context of the present teachings, a surrounding area to be mapped can potentially be identified particularly quickly, for example already before corresponding map data and/or metadata are available, for example immediately after the surrounding area is reconstructed.

In some embodiments, the method is, in particular only, applied for surrounding areas in which a data connection which is sufficient for sending the surroundings data from the fleet vehicles to the server apparatus, i.e., a sufficiently broadband or sufficiently stable data connection, cannot be set up or is not available. The surroundings data are then recorded by the sensor apparatus after the respective fleet vehicle has left the surrounding area or, alternatively, as soon as or if a data connection between the server apparatus and the respective fleet vehicle that is sufficient for sending the surroundings data is or can be set up. In other words, the method can be applied or used selectively for surrounding areas within which the surroundings data cannot be sent from the fleet vehicles to the server apparatus, for example, at all, immediately, completely, and/or reliably. This may be the case, for example, due to locally lacking data network infrastructure, poor signal or reception quality, and/or other restrictions or specifications. Surrounding areas of this kind may be, for example, parking garages, in particular multistory parking garages, but generally also indoor areas, underground areas, or the like. The application of the method only for surrounding areas of this kind can allow, firstly, for reliable mapping of such surrounding areas and, secondly, for mapping of other surrounding areas by means of other methods or processes that permit, for example, real-time or live transmission or, alternatively, streaming of the surroundings data directly from the respective surrounding area to the or a server apparatus or, alternatively, a backend or mapping server, or the like. Thus, a respectively optimal mapping method can be applied for accordingly different types of surrounding areas. This can ultimately allow for or facilitate particularly fast, effective, and reliable generation of particularly complete maps.

Within the surrounding areas for which the method is applied, the fleet vehicles that are stationary or moving there can, for example, autonomously recognize or decide whether they can record the or a subarea to be mapped or, alternatively, whether they stop in or approach the or a subarea to be mapped. This may take place or be carried out, for example, based on a mapping plan, the route network map, and/or corresponding instruction data in each case potentially in conjunction with the odometry data, an ego-motion estimation, a SLAM method (simultaneous localization and mapping), and/or the like.

In some embodiments, the at least one subarea still to be mapped or to be mapped next is defined, in particular only, by indicating the already mapped subareas and excluding same from the further collection of surroundings data or rather excluding same from the further mapping. Subareas that have already been mapped sufficiently well or completely are thus explicitly excluded from the further mapping here. This can then, in particular, implicitly define the remaining subareas as still to be mapped or to be mapped next, without these remaining subareas being or having to be explicitly designated or indicated as still to be mapped or to be mapped next. In other words, the subareas still to be mapped or to be mapped next are, in this case, thus defined by a negative or inverse indication. The subareas to be mapped are thus the remainder of the surrounding area that is different from the already mapped subareas. This indication or definition of the at least one subarea still to be mapped can be useful, in particular, in an initial phase in which the mapping of the respective surrounding area is started, for example completed by less than 50% or less than 25%. In this phase, the indication or definition of the at least one subarea to be mapped proposed here can potentially take place in a particularly simple manner or, alternatively, with a particularly low data amount or data volume by indicating or defining the already mapped subareas. In addition, all fleet vehicles moving outside of the already mapped subareas continuously contribute to the mapping of the surrounding area, even if they, for example, do not approach a particular subarea still to be mapped or when their surroundings sensor system cannot completely record a surrounding area when said vehicles travel therethrough.

With increasing progression of the method or rather of the mapping of the respective surrounding area, it can tend to be rather problematic that too much potentially redundant surroundings data come in or rather are recorded by the server apparatus and/or the definition of the already mapped subareas becomes more cumbersome than explicitly defining or indicating the subareas that are still to be mapped or that are to be mapped next. In this case, the corresponding strategy for defining the subareas still to be mapped or, alternatively, for accordingly instructing the fleet vehicles can be modified, in particular to an explicit indication or definition, i.e., a positive definition of the at least one subarea still to be mapped or to be mapped next.

Accordingly, it is provided in some embodiments that the at least one subarea still to be mapped or to be mapped next is defined, in particular only, by explicitly indicating or designating said subarea as such in the mapping plan. Thus, in other words, a positive definition takes place here, i.e., an explicit indication or designation of the at least subarea still to be mapped or to be mapped next. Here, already mapped subareas can potentially also be designated or data or indications relating to already mapped subareas can be avoided, i.e., not indicated or not included. This can potentially reduce or save a volume of corresponding data or indications to be sent or to be processed. The at least one subarea still to be mapped or to be mapped next can initially follow on from an entrance into the surrounding area and, in the further course of the method, then follow on in each case from at least one already mapped subarea. In this way, piecewise or sectionwise mapping of the respective surrounding area in exploratory fashion from the point of entry or rather entrance into said surrounding area can be realized. This can be useful, for example, in order to allow for a particularly accurate and reliable spatial relation or assignment of the surroundings data, since, for example, errors due to inaccurate odometry data or ego-motion estimations of the fleet vehicles on their way from the entrance through other subareas still to be mapped to another more distant subarea still to be mapped or when using another entrance into the surrounding area can be avoided. As a result, the map of the surrounding area can ultimately be generated in a particularly consistent manner and without errors.

In some embodiments, the fleet vehicles are informed or, alternatively, accordingly instructed by means of the server apparatus in each case only when they approach the respective surrounding area to be mapped up to a predefined distance over the at least one subarea of said surrounding area still to be mapped or to be mapped next. As a result, data transmission from the server apparatus to the fleet vehicles can be realized as needed. This can reduce a data volume to be sent by the server apparatus or rather to be transmitted to the fleet vehicles. By means of the embodiment proposed here, the respective surrounding area can be mapped in a particularly reliable manner if the fleet vehicles, for example, only have limited storage capacities for corresponding instructions for collecting the surroundings data or, alternatively, for corresponding definitions of the subareas still to be mapped that are not sufficient for corresponding data or indications for multiple or all surrounding areas still to be mapped.

Equally, corresponding data, i.e., mapping instructions or subarea definitions and/or the like, relating to the subareas still to be mapped and/or relating to the subareas of the respective surrounding area that have already been mapped or multiple or all surrounding areas still to be mapped at least in part, can be sent from the server apparatus to all fleet vehicles. As a result, particularly reliable transmission of the corresponding data from the server apparatus to the fleet vehicles can potentially be achieved, for example even if there is no or only limited data connectivity or data connection quality in the wider surroundings of the or a surrounding area. In addition, location monitoring of the fleet vehicles can then potentially be dispensed with.

The instructions sent to the fleet vehicles may comprise, for example, the previously created route network map as well as the mapping plan or a subarea definition of the subareas still to be mapped and/or of the subareas of the respective surrounding area that have already been mapped. Equally, the server apparatus may, for example, in particular additionally, send the map of the respective surrounding area that has so far already been generated in each case and that is potentially still incomplete to the fleet vehicles or, alternatively, to the respective fleet vehicle. The fleet vehicles can then use this map for navigation or, alternatively, localization within the respective surrounding area. This can allow for particularly accurate or reliable recognition or rather particularly accurate and reliable location, by the fleet vehicles, of the subareas still to be mapped.

In some embodiments, not the entire route network map, but rather orientation data that comprise a comparatively smaller, i.e., a lower data volume or rather that occupy less storage space are sent from the server apparatus to the fleet vehicles for the purpose of instructing the fleet vehicles. Said orientation data make it possible for the fleet vehicles to recognize or monitor their approach to the at least one subarea of the respective surrounding area still to be mapped or to be mapped next. For example, orientation data of this kind, i.e., which are, for example, compressed or particularly compact, can be automatically generated in each case as needed by the server apparatus. It is provided in the present case that the orientation data indicate or comprise individual route points, in particular leading from a entrance into the surrounding area to the respective subarea to be mapped and which are reduced compared with the complete route network map and/or indicate or comprise a sequence of driver events or driving maneuvers, in particular leading from the entrance into the surrounding area to the subarea to be mapped. Orientation data of this kind may be more compact than the complete route network map and can thus save a corresponding data volume to be transmitted and a corresponding data processing effort. The orientation data may be reduced as appropriate such that they can allow the fleet vehicles to recognize or track the approach to the subarea to be mapped, but do not have to allow for automated navigation for the fleet vehicles.

If, when traveling through the respective surrounding area, a fleet vehicle recognizes—based on the orientation data and, for example, its own odometry data, an ego-motion estimation, or other localization data—that the subarea to be mapped is not actually being or likely to be approached, the orientation data and/or the respective instruction can be discarded by the server apparatus. Then, in the course of the method, it is possible to wait for the next fleet vehicle to travel through the respective surrounding area in order to record further surroundings data, i.e., to continue with the mapping of the respective surrounding area.

In some embodiments, the mapping plan defines the at least one subarea still to be mapped or to be mapped next and/or subareas that have already been mapped partially or completely and does so individually, i.e., separately or specifically for surroundings data that have been recorded or, alternatively, can be recorded or collected by different types of surroundings sensors. The mapping plan can thus, for example, indicate or define whether there are still no data at all for a particular subarea or, for example, whether there is already a particular type of surroundings data, but there is still no other type of surroundings data for this subarea. For example, radar data or radar echoes may already have been recorded for a particular subarea, but still no lidar or camera data or the like. The corresponding subarea can then be classed or classified or, alternatively, defined as already mapped specifically for surroundings data recorded by means of a radar apparatus, while said subarea can be designated or classified or, alternatively, defined as still to be mapped for surroundings data recorded by means of a lidar apparatus or a camera or the like. The mapping plan or, alternatively, the instructions for the fleet vehicles may then provide that only the respectively missing or rather as of yet unrecorded types of surroundings data are to be collected and transmitted for the subareas that have not yet been mapped completely, thus in this case lidar data and/or camera data, but no further radar data are to be collected and transmitted.

In this sense, subareas that not have been completely mapped may thus be subareas which still have not been recorded, scanned, or imaged with all predefined types of surroundings sensors or, alternatively, they may be subareas for which all predefined types of surroundings data have not yet been recorded.

On account of the embodiment proposed here, the surrounding area may also be at least partially mapped in a particularly fast and comprehensive manner, for example, with different equipment of the fleet vehicles, i.e., if the fleet vehicles have different types of surroundings sensors, and/or if particular types of surroundings data can only be recorded, for example, under particular environmental conditions. This allows for at least preliminary support of functions reliant on map data particularly fast or early on after the respective surrounding area has been identified or located. In addition, on account of the embodiment proposed here, the redundancy of transmitted surroundings data can be further reduced and thus the data processing effort can accordingly be saved.

Another aspect of the present disclosure relates to a vehicle-external server apparatus. The server apparatus comprises an input interface for recording input data from a plurality of fleet vehicles. Said input data may, in particular, be or comprise the odometry and surroundings data mentioned in conjunction with the discussed method. The server apparatus further comprises a data processing apparatus for processing the recorded input data into a route network map, a mapping plan, and ultimately a map for a surrounding area. Furthermore, the server apparatus comprises an output interface for sending output data to the fleet vehicles. Said output data may, in particular, be or comprise instructions by means of which the fleet vehicles are instructed to collect and send the surroundings data for at least one subarea of the surrounding area still to be mapped or to be mapped next. For example, the output data may, for this purpose, be or comprise at least parts of the route network map, parts of the mapping plan, and/or some of the orientation data mentioned in conjunction with the method as well as the map of the respective surrounding area that was created in the meantime or ultimately by the server apparatus.

The assistance apparatus according to the teachings herein is configured to execute or carry out, in particular automatically or semi-automatically, at least one variant or embodiment of the method. Accordingly, the server apparatus may, in particular, be or correspond to the server apparatus mentioned in conjunction with the discussion of the methodherein. The server apparatus may also comprise some or all of the features and/or properties mentioned in conjunction with the method.

Another aspect relates to a motor vehicle. The motor vehicle may, in particular, be or correspond to one of the fleet vehicles mentioned in conjunction with the method discussed herein and/or in conjunction with the server apparatus discussed herein. The motor vehicle comprises a surroundings sensor system and a data processing apparatus for collecting surroundings data that characterize or depict respective surroundings of the motor vehicle. The surroundings sensor system or the data processing apparatus may thus be designed and configured, for example, to record the surroundings data or to record raw data and to process or pre-process said raw data into the surroundings data. The motor vehicle further comprises a storage apparatus for temporarily storing the surroundings data locally, i.e., on the vehicle side, and a communication apparatus for wireless data exchange with the or a server apparatus.

In response to receiving a corresponding instruction from the server apparatus, the motor vehicle is configured to collect surroundings data only for at least one subarea of the surrounding area to be mapped in accordance with the instruction or, alternatively, to be recorded by means of the vehicle's own surroundings sensor system when said motor vehicle travels through a surroundings area specified in said instruction and to send said surroundings data to the server apparatus. In particular, the motor vehicle may be configured to temporarily store the collected surroundings data initially in the storage apparatus, in particular at least until a corresponding data connection for sending the surroundings data to the server apparatus is or, alternatively, can be set up. The motor vehicle may thus, as described in conjunction with the method, be configured to participate in or support the method. Accordingly, the motor vehicle may comprise some or all of the properties and/or features and/or embodiments mentioned in conjunction with the other aspects of the present disclosure, in particular for the fleet vehicles.

The fact that the server apparatus or, alternatively, the motor vehicle are configured accordingly as described can mean, for example, that a corresponding operating or computer program is stored, i.e., saved, in a respective data processing apparatus or, alternatively, a respective data memory, which operating or computer program represents, i.e., codes or implements, the respectively described procedures, measures, or method steps. Said operating or computer program can be executed by means of the data processing apparatus or a respective processor apparatus of the server apparatus or, alternatively, of the motor vehicle, i.e., for example, a microchip, microprocessor, or microcontroller, or the like, in order to automatically execute the respective method or rather the above-mentioned measures, procedures, or method steps or in order to prompt, in particular automatic, execution thereof.

Another aspect of the present disclosure may relate to a system that at least comprises the apparatuses or devices involved in the method, i.e., in particular, the vehicle-external server apparatus and at least one motor vehicle according to the teachings herein or a fleet of such motor vehicles. The components of the system may interact in order to execute or apply the method of the teachings herein, i.e., in order to automatically map at least one surrounding area.

Other features of the invention can be apparent in the following description of the FIG. and with reference to the drawing. The features and combinations of features mentioned in the preceding in the description, as well as the features and combinations of features presented in the following in the description of the FIG. and/or just in the FIG., can be used not only in the mentioned combination, but also in other combinations or by themselves without departing from the scope of the invention.

For the sake of clarity, only a representative selection of elements that occur multiple times is explicitly designated in the FIGURE.

Today, work is being done on the automatic mapping of regions, in particular traffic areas, based on data collected by a fleet of vehicles. This involves challenges, in particular in complex or—for example due to limited or non-existent data connectivity—demanding regions or surrounding areas. One approach can consist in using detectors which can generate map contents, for example walls, columns, ramps, and/or the like, from sensor data collected by the fleet vehicles. It may be expedient for the fleet vehicles to collect and report, for example, radar detections as sensor or surroundings data of this kind, such that a corresponding detector has as broad a data base as possible available, consisting of sensor or surroundings data of multiple fleet vehicles. Thus, corresponding map contents can be generated in a particularly reliable and robust manner. However, sensor or surroundings data of this kind—either in the form of raw data or in the form of already pre-processed data—cannot be transmitted to a vehicle-external apparatus for generating the map contents everywhere without a problem, in particular live or in real time, for example due to lacking communication infrastructure, mobile coverage, and/or the like. Although this problem could be countered by temporarily storing the sensor or surroundings data in the fleet vehicles, in practice this is not readily possible due to the associated hardware and costs—at least not for entire regions or surrounding areas, for example entire parking garages or similar domains.

An exemplary solution to the above-mentioned problems or challenges is described in the following, which solution is based on the implementation of more fine-grained campaign management for a vehicle fleet for recording surroundings data in order to ultimately map a respective surrounding area completely.

The FIGURE shows, by way of example, a sectional overview of a road 1, from which a surrounding area to be mapped, in this case in the form of a parking garage 2, can be reached via a corresponding entrance 3. Here, the parking garage 2 comprises, by way of example, a plurality of parking areas 4 and driving areas 5, through which vehicles can travel. The parking garage 2 may also comprise multiple levels or floors which may potentially have different arrangements or layouts of the parking areas 4 and driving areas 5 and/or other areas.

In order to carry out or support a method for mapping the parking garage 2, a vehicle-external server apparatus 6 and one or more motor vehicles 7 are represented here. The motor vehicle representations here can, for example, show two different motor vehicles 7 of said vehicle fleet or a single motor vehicle 7 at different times.

The server apparatus 6 comprises a server data interface 8, a server processor 9, and a server data memory 10. Thus, the server apparatus 6 is configured for, in particular bidirectional, data exchange with the motor vehicle 7 and for data processing.

The motor vehicle 7 comprises a surroundings sensor system 11 as well as a data processing apparatus 12. The surroundings sensor system 11 may comprise one or more surroundings sensors, for example a radar apparatus, a lidar apparatus, an ultrasonic apparatus, a camera, and/or the like. The data processing apparatus 12 here comprises, schematically, a vehicle processor 13 and a vehicle data memory 14. Furthermore, the motor vehicle 7 comprises a communication apparatus 15 for, in particular wireless, data exchange with the server apparatus 6.

The parking garage 2 can first be identified as a surrounding area to be mapped. This may take place, for example, in that the parking garage 2 is explored by the motor vehicle 7 and in that the parking garage 2 is identified by means of the server apparatus 6, for example based on predefined map data or metadata which are potentially incomplete with regard to an internal structure or internal mapping of the parking garage 2.

The motor vehicle 7, which represents the vehicle fleet, can travel through or, alternatively, explore the parking garage 2 and record odometry data in the process. Said odometry data may indicate vehicle positions or vehicle movements of the respective motor vehicle 7 within the parking garage 2, for example with respect to a predefined coordinate system. Said predefined coordinate system may, for example, be oriented or aligned with the entrance 3 or the road 1 if it is possible there, unlike the parking garage 2 for example, to locate or determine the position of the motor vehicle 7, for example by means of a navigation satellite system or the like.

After the respective motor vehicle 7 has left the parking garage 2, said motor vehicle can send the odometry data recorded therein, in particular temporarily stored in the vehicle data memory 14, to the server apparatus 6. The odometry data may, for example, comprise current 3D coordinates of the respective motor vehicle 7 determined at intervals of 100 ms in each case, potentially with the addition of one or more angle indications that indicate an alignment of the respective motor vehicle 7 at the respective time. Equally, the odometry data may, for example, indicate at least or exactly two spatial coordinates and a yaw angle of the respective motor vehicle 7 for each point or position. Equally, other configurations, compositions, data contents, or recording frequencies of the odometry data are also possible.

The respective odometry data are received by the server apparatus 6 via the server data interface 8. Based on the recorded odometry data, the server apparatus 6 automatically generates or reconstructs a route network, i.e. a route network map 16 of the parking garage 2. The route network map 16 may thus comprise or indicate regions or trajectories within the parking garage 2 through or along which the at least one motor vehicle 7 has actually traveled. The route network map 16 can be averaged or smoothed based on odometry data of a plurality of motor vehicles 7.

In this first phase of the method, the motor vehicles 7 of the vehicle fleet may thus be configured such that they only record their odometry data, potentially temporarily store same and send same to the server apparatus 6. As a result, the route network map 16 can be reliably and completely reconstructed or generated even with a limited storage capacity of the vehicle data memories 14.

In a second phase of the method, the server apparatus 6 generates a mapping plan 17 based on the route network map 16. The mapping plan 17 divides the parking garage 2, i.e. in general terms the respective surrounding area to be mapped, into multiple subareas 18. A size of the subareas 18 may be or may have been defined, for example, depending on the predefined, known, or expected size or rather data storage capacity of the vehicle data memories 14, such that sensor or surroundings data that characterize or depict at least one of the subareas 18 can be temporarily stored in the vehicle data memory 14. For example, radar data for the entire parking garage 2 may have a data volume in the order of one or more megabytes, whereas the vehicle data memories 14 may, for example, in each case have a capacity in the order of several, several dozen, or several hundred kilobytes or the like.

With or in the mapping plan 17, the server apparatus 6 also automatically defines which of the subareas 18 are still to be mapped or to be mapped next, i.e. are to be recorded or depicted more accurately with sensors, and/or which of the subareas 18 have potentially already been mapped. For example, it can be defined that the sensor-based recording or rather mapping of the parking garage 2 begins at the entrance 3, i.e. the motor vehicles 7 entering the parking garage 2 should start with the gathering of the sensor or surroundings data from that point on. Depending on the available temporary memory, i.e. depending on the size or capacity of the respective vehicle data memory 14, the motor vehicles 7 can then collect corresponding sensor or surroundings data when traveling through the parking garage 2 and temporarily store said data in the vehicle data memory 14. After leaving the parking garage 2, the respective temporarily stored sensor or surroundings data can be sent from the respective motor vehicle 7 to the server apparatus 6, potentially with an indication of the subarea 18 or of the section of the route network map 16 in which the respective sensor or surroundings data were recorded or rather collected.

The server apparatus 6 records said sensor or surroundings data and, based on this, determines which of the subareas 18 have already been recorded or depicted or rather mapped with sensors sufficiently well and which of the subareas 18 are potentially still to be recorded or depicted, i.e. ultimately mapped, or for which this to be done next, by means of the surroundings sensor system 11 of the motor vehicles 7.

The server apparatus 6 may generate, complete, or update a map of the parking garage 2 or, alternatively, of the respective subarea 18 based on the respectively recorded sensor or surroundings data. Sensor or surroundings data can thus be collected gradually over time for all subareas 18 by the motor vehicles 7 and recorded by the server apparatus 6 and processed into an ultimately complete map of the parking garage 2. The server apparatus 6 can thus utilize individual contributions or individual data packets from the motor vehicles 7 that are incomplete in terms of the overall extent of the parking garage 2 in order to define which of the subareas 18 have already been recorded or rather mapped with sensors and continuously or regularly adapt the mapping plan 17 or, alternatively, corresponding instructions to the motor vehicles 7 in order to limit or prevent redundant data transmissions and gradually have the entire parking garage 2 recorded and thus ultimately mapped by the motor vehicles 7 or rather the surroundings sensor systems 11 thereof. This procedure ultimately makes it possible to also fully map the parking garage 2 if motor vehicles 7 inside the parking garage 2 are unable to set up a data connection to the server apparatus 6 and the motor vehicles 7 only have limited storage capacities for temporarily storing the sensor or surroundings data and potentially have different surroundings sensor systems 11.

In order for the respective motor vehicle 7 to know, i.e. can autonomously or automatically recognize, whether it is approaching or traveling through the subarea 18 still to be mapped in each case and, accordingly, whether it should collect sensor or surroundings data, the server apparatus 6 can send the route network map 16 and/or the mapping plan 17 as well as an indication of subareas 18 to be recorded or mapped to the respective motor vehicle 7 or, alternatively, to all motor vehicles 7 of the vehicle fleet. This may take place, for example, as soon as the route network map 16 or, alternatively, the mapping plan 17 has been created or updated or, for example, only if the respective motor vehicle 7 has approached the parking garage 2 up to a predefined distance and/or the parking garage 2 has, for example, been set or recognized as the navigation or intermediate destination of the respective motor vehicle 7. One possibility for identifying whether the respective motor vehicle 7 has reached the or a subarea 18 to be recorded or rather mapped within the parking garage 2 consists in the respective motor vehicle 7 automatically locating itself within the parking garage 2 based on its vehicle odometry, i.e. its odometry data and/or an ego-motion estimation or the like, potentially using or in relation to the route network map 16 and/or the mapping plan 17. Equally, if necessary in order to improve accuracy, the server apparatus 6 may not only send the route network map 16 or the mapping plan 17 to the respective motor vehicle 7, but rather also send the map already generated up to the respective point in time, i.e. a current reconstructed object map status for the parking garage 2. Using its surroundings sensor system 11, said motor vehicle can then locate itself within the parking garage 2 in relation to the map or, alternatively, a corresponding coordinate system. For this purpose, radar localization, visual localization, or localization based on lidar or radio data or the like, a SLAM method, or another localization or position determination method, for example, may be used.

Overall, the examples described show how even demanding surrounding areas can be mapped automatically.

### LIST OF REFERENCE NUMERALS

1 Road
2 Parking garage
3 Entrance
4 Parking areas
5 Driving areas
6 Server apparatus
7 Motor vehicle
8 Server data interface
9 Server processor
10 Server data memory
11 Surroundings sensor system
12 Data processing apparatus
13 Vehicle processor
14 Vehicle data memory
15 Communication apparatus
16 Route network map
17 Mapping plan
18 Subareas

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for automatically mapping a surrounding area, comprising, by a vehicle-external server automatically:
recording odometry data that were collected by fleet vehicles while traveling through the surrounding area and that indicate positions within the surrounding area traveled to by the fleet vehicles;
creating a route network map for the surrounding area from the odometry data;
creating a mapping plan for mapping sections of the surrounding area based on the route network map, which mapping plan splits the surrounding area into multiple subareas and defines at least one subarea of the surrounding area that is still to be mapped by the fleet vehicles; and
iteratively instructing the fleet vehicles in accordance with the mapping plan to collect surroundings data upon a next travel through the surrounding area using a respective vehicle-specific surroundings sensor system only for the at least one subarea still to be mapped and to transmit said data to the server; and
generating a map of the surrounding area and updating the mapping plan based on the cumulatively received surroundings data in order to prevent redundant surroundings data for already mapped subareas of the surrounding area from being collected and transmitted by the fleet vehicles.

12. The method of claim 11, wherein the surrounding area is identified based on predefined map data and/or metadata that identify the surrounding area as a trafficable area, without indicating a detailed map of the surrounding area.

13. The method of claim 11, wherein the method is applied for surrounding areas in which a sufficient data connection for sending the surroundings data from the fleet vehicles to the server cannot be set up, wherein the surroundings data are then recorded by the server after the respective fleet vehicle has left the surrounding area.

14. The method of claim 11, wherein the at least one subarea still to be mapped is defined by indicating the already mapped subareas and excluding same from the further collection of surroundings data.

15. The method of claim 11, wherein the at least one subarea still to be mapped is defined by explicitly indicating them as such in the mapping plan.

16. The method of claim 11, wherein the fleet vehicles are informed by the server in each case only when they approach the respective surrounding area up to a predefined distance over the at least one subarea of said surrounding area still to be mapped.

17. The method of claim 11, wherein, for the purpose of instructing the fleet vehicles, not the entire route network map, but rather a comparatively smaller amount of orientation data that make it possible for the fleet vehicles to recognize their approach to the at least one subarea that is still to be mapped are sent from the server to the fleet vehicles, wherein the orientation data indicate individual route points, in particular leading from an entrance into the surrounding area to the respective subarea to be mapped, and/or indicate a sequence of driver events, in particular leading from an entrance into the surrounding area to the subarea to be mapped.

18. The method of claim 11, wherein the mapping plan defines the at least one subarea still to be mapped and/or subareas that have already been mapped individually for surroundings data that have been recorded by different types of surroundings sensors.

19. A vehicle-external server, comprising an input interface for recording input data from a plurality of fleet vehicle, a data processor for processing the recorded input data into a route network map, a mapping plan, and a map for a surrounding area, and an output interface for sending output data to the fleet vehicle, wherein the server is configured to:
record odometry data that were collected by fleet vehicles while traveling through the surrounding area and that indicate positions within the surrounding area traveled to by the fleet vehicles;
create a route network map for the surrounding area from the odometry data;
create a mapping plan for mapping sections of the surrounding area based on the route network map, which mapping plan splits the surrounding area into multiple subareas and defines at least one subarea of the surrounding area that is still to be mapped by the fleet vehicles; and
iteratively instruct the fleet vehicles in accordance with the mapping plan to collect surroundings data upon a next travel through the surrounding area using a respective vehicle-specific surroundings sensor system only for the at least one subarea still to be mapped and to transmit said data to the server; and
generate a map of the surrounding area and updating the mapping plan based on the cumulatively received surroundings data in order to prevent redundant surroundings data for already mapped subareas of the surrounding area from being collected and transmitted by the fleet vehicles.

20. A motor vehicle, comprising a surroundings sensor system and a data processing apparatus for collecting surroundings data which characterize a respective surroundings of the motor vehicle, a data storage for temporarily storing the surroundings data on the vehicle side, and a communication interface for wireless data exchange with a vehicle-external server of claim 19, wherein the motor vehicle is configured, in response to receiving a corresponding instruction from the server, to collect surroundings data only for a subarea of the surrounding area to be mapped in accordance with the instruction when traveling through a surroundings area specified in said instruction, to temporarily store said surroundings data in the storage apparatus, and to send said surroundings data to the server.

21. The method of claim 13, wherein the method is only applied for surrounding areas in which a sufficient data connection for sending the surroundings data from the fleet vehicles to the server cannot be set up.

22. The vehicle-external server of claim 19, wherein the surrounding area is identified based on predefined map data and/or metadata that identify the surrounding area as a trafficable area, without indicating a detailed map of the surrounding area.

23. The vehicle-external server of claim 19, wherein iteratively instructing is applied for surrounding areas in which a sufficient data connection for sending the surroundings data from the fleet vehicles to the server cannot be set up, wherein the surroundings data are then recorded by the server after the respective fleet vehicle has left the surrounding area.

24. The vehicle-external server of claim 19, wherein the at least one subarea still to be mapped is defined by indicating the already mapped subareas and excluding same from the further collection of surroundings data.

25. The vehicle-external server of claim 19, wherein the at least one subarea still to be mapped is defined by explicitly indicating them as such in the mapping plan.

26. The vehicle-external server of claim 19, wherein the fleet vehicles are informed by the server in each case only when they approach the respective surrounding area up to a predefined distance over the at least one subarea of said surrounding area still to be mapped.

27. The vehicle-external server of claim 19, wherein, for the purpose of instructing the fleet vehicles, not the entire route network map, but rather a comparatively smaller amount of orientation data that make it possible for the fleet vehicles to recognize their approach to the at least one subarea that is still to be mapped are sent from the server to the fleet vehicles, wherein the orientation data indicate individual route points, in particular leading from an entrance into the surrounding area to the respective subarea to be mapped, and/or indicate a sequence of driver events, in particular leading from an entrance into the surrounding area to the subarea to be mapped.

28. The vehicle-external server of claim 19, wherein the mapping plan defines the at least one subarea still to be mapped and/or subareas that have already been mapped individually for surroundings data that have been recorded by different types of surroundings sensors.

29. The motor vehicle of claim 20, wherein the surrounding area is identified based on predefined map data and/or metadata that identify the surrounding area as a trafficable area, without indicating a detailed map of the surrounding area.

30. The motor vehicle of claim 20, wherein the method is applied for surrounding areas in which a sufficient data connection for sending the surroundings data from the fleet vehicles to the server cannot be set up.
